(19) United States
(12) Patent Application Publication
(10) Pub. No.: US 2022/0366300 A1
(43) Pub. Date: Nov. 17, 2022

(54) DATA DRIFT MITIGATION IN MACHINE LEARNING FOR LARGE-SCALE SYSTEMS

(71) Applicant: Microsoft Technology Licensing, LLC, Redmond, WA (US)

(72) Inventors: Tsuwang HSIEH, Redmond, WA (US); Behnaz ARZANI, Redmond, WA (US); Ankur MALLICK, Pittsburgh, PA (US)

(21) Appl. No.: 17/322,184

(22) Filed: May 17, 2021

(51) Int. Cl. G06N 20/00

(52) U.S. Cl. CPC G06N 20/00

(57) ABSTRACT

A cloud-based service uses an offline training pipeline to categorize training data for machine learning (ML) models into various clusters. Incoming test data that is received by a data center or in a cloud environment is compared against the categorized training data to identify the appropriate ML model to assign the test data. The comparison of the test data is done in real-time using a similarity metric that takes into account spatial and temporal factors of the test data relative to the categorized training data.

### BACKGROUND

Data centers need to meet ever-increasing demands while achieving various operational objectives. Machine learning (ML) is vital in making various decisions for data centers during operation. Developers have deployed ML models for various tasks such as resource management, power management, data indexing, temperature management, and failure/compromise detection. The accuracy of these ML models often has significant impact on the performance, security, and efficiency of data center operations. Decreases in accuracy lead to performance degradation and cost increases. It is common for a large cloud provider to suffer accuracy drops up to 40% due to the inefficient operations stemming from underperformance of ML models.

Unlike ML applications like image classification and natural language processing where the data typically comes from a stable underlying sample space, most cloud applications involve data that is inherently temporal and that can change over time. These changes occur because operational data centers constantly face internal and external changes, such as system upgrades, configuration changes, new workloads, and surging user demands. This, in turn, results in what is known in the ML community as data drift: a mismatch between the training and test data.

Data drift results in significant accuracy drops because the assumption on which most ML models are trained, that the training data in the past is sufficiently similar to the test data in the future, is often untrue. The ML community classifies the data drift problem into two broad categories: (1) covariate shifts (or virtual drift) where training data distribution changes over time but the underlying concept (the mapping from features to labels) stays the same; and (2) concept drift (or real drift) where the underlying concept changes over time. Both types of data drift are hugely and negatively impactful on today's ML models applied to data centers.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Examples and implementations disclosed herein are directed to a cloud-based service for selecting an ML model for test data from a plurality of ML models in large-scale cloud environment. The service (referenced below as the Matchmaker service) includes an offline training pipeline that batches training data in the cloud environment into a plurality of batches, determines first distances for the training data relative to each other, and determines clusters of the training data based on the first distances. The service also includes an online matching pipeline that calculates a similarity metric for the test data indicative of spatial nearness and temporal nearness and selects the ML model for processing the test data based on the similarity metric. The similarity metric, in particular, is calculated with a spatial nearness factor and a temporal nearness factor to identify the combination of closest and most-timely training data for incoming test data received by the cloud environment, which is then usable to identify the appropriate ML model for handling that test data.

### BRIEF DESCRIPTION OF THE DRAWINGS

The disclosed examples are described in detail below with reference to the accompanying drawing figures listed below:

FIG. 1 illustrates a block diagram of an example computing device for implementing aspects disclosed herein;

FIG. 2 illustrates a block diagram of a networking environment with a service that reduces data drift in ML models, according to some of the disclose embodiments;

FIG. 3 illustrates a graphical representation of operations of an offline training pipeline, according to some of the disclosed embodiments;

FIG. 4 illustrates a graphical representation of operations of an online matching pipeline, according to some of the disclosed embodiments.

FIG. 5 illustrates graphical representations of partitioning of training data using decision trees, according to some of the disclosed embodiment;

FIG. 6 illustrates a flow chart diagram of an operational flow for associating training data with ML models in a large-scale cloud environment or data center, according to some of the disclosed embodiments;

FIG. 7 illustrates a flow chart diagram of an operational flow 700 for selecting an ML model for test data from a plurality of ML models in large-scale cloud environment; and

FIG. 8 illustrates a block diagram of an example cloud-computing environment.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As previously discussed, ML models today are trained on historical data. The more data used to train the ML model, the better the model will typically perform. But there is an operational tradeoff insofar as the more data used to train a model requires more the processing and memory resources, and even then, there is no guarantee that future data used by the trained ML model will match the historical data used to train it. Real or virtual data drift causes the ML models to perform inaccurately—or, at least, in ways that are not modeled during training—because future data does not always look like past data used for training.

Covariate data drift is a result of future values for data coming from different sources, but the underlying mapping of the future data to labels is accurate. For example, an ML model may be designed to predict the correct team of an organization to route customer service incidents—typically referred to as “incident routing”—and historically the particular incidents routed to one team come from a specific area of a data center (e.g., network connectivity for a web site), but then future problems routed to that team start coming from another area of the data center (e.g., glitches in content for the website). In other words, the population of the future data needing to be routed to the team changes, from network connectivity issues too glitches in content for the website. So, if there is a shift in the population of the data, the ML model may not work very well in the future. These are just some, though definitely not all, examples of covariate drift impacting ML models based on future data coming from different resources.

Concept drift is a result of the past data in the future data looking the same, but the ground truth data ends up changing. Obviously, this impacts the prediction ability of the ML model. For example, a web user may look at the same website but the advertisements on the website may change period so, from the ML models perspective, the behavior is the same: the user is looking at the same web page. But the user's preference has changed, resulting in the different advertisements being displayed. Or, in another example, a system upgrade may before the same system, but the particular upgrade being implemented may use more processing and memory resources than previous upgrades. Again, the ML model sees the same type of upgrade, but the behavior is different because the number of processing resources needed has changed. These are just some, though definitely not all, examples concept drift impacting ML models based on ground truths changing.

In reality, both covariate drift and concept drift frequently occur at the same time. This makes it quite difficult for ML models to be accurate in today's large-scale cloud environments.

Aside from data drift, ground truth latency also impacts the accuracy of ML models. Ground truths are outcomes of particular scenarios that are used to train ML models. In the example of incident routing, ML models are used to try an automatically interpret and route incidents to the appropriate teams. But the affectedness of that routing, whether the incidents are routed to the correct teams, is only known after the teams receive the incident. Ground truths are therefore created to indicate whether or not the incidents were correctly routed. This kind of testing of whether or not data correctly matched the ML mode's prediction takes time, which is often referred to as “ground truth latency.” In other words, the ML model's predictions must be verified against actual incidents, taking considerable time and resources for improving the ML model.

A data-matching cloud service (referred to herein as “Matchmaker” and the “Matchmaker service”) is disclosed herein that develops more accurate ML models in the face of data drift and ground truth latency within large-scale data centers and cloud environments. The Matchmaker service addresses the two main underlying causes of data drift: different batches of data are significantly different samples from the sample space (covariate shift), or represent different underlying relationships between variables (concept drift). More specifically, the Matchmaker service identifies a batch of training data that is most similar to a new test sample and uses the model trained on that batch to develop an inference. The Matchmaker service does this, in some embodiments, by training ML models for different batches of training data (e.g., X models for X batches). Sample data is partitioned, for instance by training a random forest, R, on all labeled batches (X₁, y₁), . . . , (X_{T}, y_{T}). The model may then be used to partition the space of training samples.

The training batches are compared, spatially, to a given test data sample for an ML model, and the training batches are ranked based on their spatial nearness to a given test sample. In some embodiments, this is done through identifying leaf nodes that a test sample is mapped to in sample forest R and then using this information to rank the training batches (X₁, y₁), . . . , (X_{T}, y_{T}). Some embodiments specifically use the Borda Count algorithm to do such ranking. In addition to spatial rankings, temporal rankings are also used. For instance, the most recent batch may be ranked highest. Such ranking may also use the Borda Count algorithm. Once spatial and temporal rankings are computed, Matchmaker uses the model that corresponds to the highest ranked batch to run and generate an inference for a given test sample.

In some embodiments, the Matchmaker service executes the training and matching operations offline. The remaining operations are executed during inferencing and are repeated for each new test instance. The Matchmaker service does not depend on the type of model (e.g., deep neural networks (DNNs), support vector machines (SVMs), or random forest) the operator is using in deployment, thereby providing enormous flexibility. Yet, the disclosed embodiments have shown to be accurate and stable under various forms of data drift (adaptability), and that it is significantly faster than traditional data-drift services.

In some embodiments, the Matchmaker service uses scikit-learn to train a random forest as a data partitioning kernel. For all leaf nodes in a random forest, the Matchmaker service precomputes spatial rankings for each of a collection of training batches (X₁, y₁), . . . (X_{T}, y_{T}). The spatial rankings may be stored as a lookup table, and a single lookup to the table is used, in some embodiments, to retrieve the spatial ranking once we know the traversal paths of a given test sample.

In operation, the Matchmaker service dynamically identifies the batch of training data that is most similar to each test sample of an ML model and uses the ML model trained on that data for inferencing. The Matchmaker service selects the matching ML model for each sample at test time, and it adapts to data drifts without having to wait for new ground truth labels to retrain. Also, the Matchmaker service has the flexibility to make independent decisions on each test sample that is more effective than existing data drift solutions that always use the same ML model (or the same set of ML models) for all incoming test samples until they do another round of adaptation. Further still, the Matchmaker service provides operators with the means to select their own similarity metric: ML practitioners may choose which similarity metric achieves the right trade-off for them in terms of computation overhead and model accuracy.

To do all this, the Matchmaker service uses a new similarity metric that measures a combination of spatial nearness (e.g., similarity in feature values) with temporal nearness (e.g., similarity in data generation time). This metric allows the Matchmaker service to mitigate both covariate shift and concept drift with significantly less computational overhead than existing metrics. The Matchmaker service is designed for large-scale cloud- or data-center infrastructures that make, perhaps, millions of predictions a day.

The Matchmaker service mitigates data drift in large-scale data centers and cloud environments affecting ML models. The Matchmaker service uses a new similarity metric that combines similarity in ML data values (spatial nearness) and similarity in data generation time (temporal nearness). The Matchmaker service presents an efficient design to compute this similarity metric by splitting the work between an online and offline processing pipelines.

Having provided an overview of some of the disclosed implementations and examples and clarified some terminology, attention is drawn to the accompanying drawings to further illustrate additional details. The illustrated configurations and operational sequences are provided to aid the reader in understanding various aspects of the disclosed implementations and examples. The accompanying figures are not meant to limit all examples, and thus some examples may include different components, devices, or operations while not departing from the scope of the examples disclosed herein. In other words, some implementations and examples may be embodied or may function in different ways than those shown.

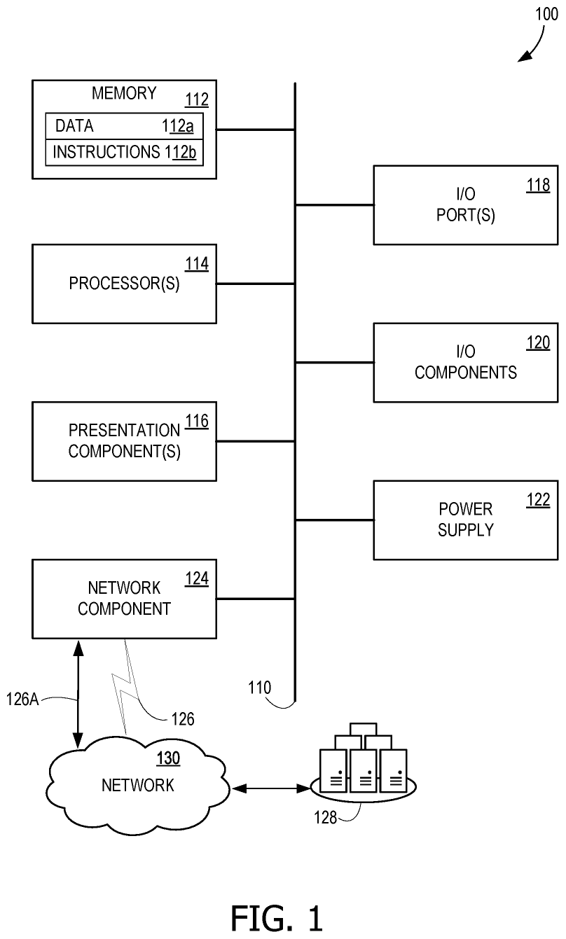

FIG. 1 is a block diagram of an example computing device 100 for implementing aspects disclosed herein, and is designated generally as computing device 100. Computing device 100 is but one example of a suitable computing environment and is not intended to suggest any limitation as to the scope of use or functionality of the examples disclosed herein. Neither should computing device 100 be interpreted as having any dependency or requirement relating to any one or combination of components/modules illustrated.

The examples disclosed herein may be described in the general context of computer code or machine- or computer-executable instructions, such as program components, being executed by a computer or other machine. Generally, program components include routines, programs, objects, components, data structures, and the like that refer to code, performs particular tasks, or implement particular abstract data types. The disclosed examples may be practiced in a variety of system configurations, including personal computers, laptops, smart phones, servers, VMs, mobile tablets, hand-held devices, consumer electronics, specialty computing devices, etc. The disclosed examples may also be practiced in distributed computing environments when tasks are performed by remote-processing devices that are linked through a communications network.

Computing device 100 includes a bus 110 that directly or indirectly couples the following devices: computer-storage memory 112, one or more processors 114, one or more presentation components 116, I/O ports 118, I/O components 120, a power supply 122, and a network component 124. While computing device 100 is depicted as a seemingly single device, multiple computing devices 100 may work together and share the depicted device resources. For example, memory 112 is distributed across multiple devices, and processor(s) 114 is housed with different devices. Bus 110 represents what may be one or more busses (such as an address bus, data bus, or a combination thereof). Although the various blocks of FIG. 1 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 1 and the references herein to a “computing device.”

Memory 112 may take the form of the computer-storage memory device referenced below and operatively provide storage of computer-readable instructions, data structures, program modules and other data for the computing device 100. In some examples, memory 112 stores one or more of an OS, a universal application platform, or other program modules and program data. Memory 112 is thus able to store and access data 112a and instructions 112b that are executable by processor 114 and configured to carry out the various operations disclosed herein. In some examples, memory 112 stores executable computer instructions for an OS and various software applications. The OS may be any OS designed to the control the functionality of the computing device 100, including, for example but without limitation: WINDOWS® developed by the MICROSOFT CORPORATION®, MAC OS® developed by APPLE, INC.® of Cupertino, Calif., ANDROID™ developed by GOOGLE, INC.® of Mountain View, Calif., open-source LINUX®, and the like.

By way of example and not limitation, computer readable media comprise computer-storage memory devices and communication media. Computer-storage memory devices may include volatile, nonvolatile, removable, non-removable, or other memory implemented in any method or technology for storage of information such as computer-readable instructions, data structures, program modules, or the like. Computer-storage memory devices are tangible and mutually exclusive to communication media. Computer-storage memory devices are implemented in hardware and exclude carrier waves and propagated signals. Computer-storage memory devices for purposes of this disclosure are not signals per se. Example computer-storage memory devices include hard disks, flash drives, solid state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number an organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device, CPU, GPU, ASIC, system on chip (SoC), or the like for provisioning new VMs when configured to execute the instructions described herein.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor, by multiple processors within the computing device 100, or by a processor external to the client computing device 100. In some examples, the processor(s) 114 are programmed to execute instructions such as those illustrated in the flow charts discussed below and depicted in the accompanying figures. Moreover, in some examples, the processor(s) 114 represent an implementation of analog techniques to perform the operations described herein. For example, the operations are performed by an analog client computing device 100 and/or a digital client computing device 100.

Presentation component(s) 116 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways. I/O ports 118 allow computing device 100 to be logically coupled to other devices including I/O components 120, some of which may be built in. Example I/O components 120 include, for example but without limitation, a microphone, joystick, game pad, satellite dish, scanner, printer, wireless device, etc.

The computing device 100 may communicate over a network 130 via network component 124 using logical connections to one or more remote computers. In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, network component 124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 124 communicates over wireless communication link 126 and/or a wired communication link 126a across network 130 to a cloud environment 128, such as the cloud-computing environment depicted in FIG. 12. Various different examples of communication links 126 and 126a include a wireless connection, a wired connection, and/or a dedicated link, and in some examples, at least a portion is routed through the Internet.

The network 130 may include any computer network or combination thereof. Examples of computer networks configurable to operate as network 130 include, without limitation, a wireless network; landline; cable line; digital subscriber line (DSL): fiber-optic line; cellular network (e.g., 3G, 4G, 5G, etc.); local area network (LAN); wide area network (WAN): metropolitan area network (MAN); or the like. The network 130 is not limited, however, to connections coupling separate computer units. Rather, the network 130 may also include subsystems that transfer data between servers or computing devices. For example, the network 130 may also include a point-to-point connection, the Internet, an Ethernet, an electrical bus, a neural network, or other internal system. Such networking architectures are well known and need not be discussed at depth herein.

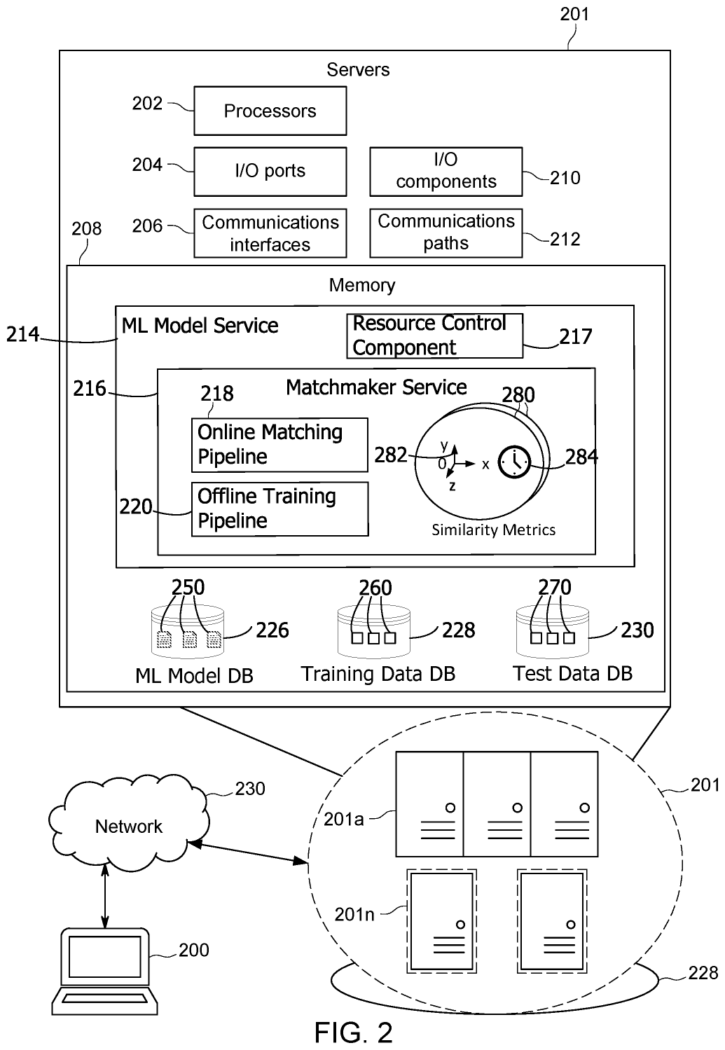

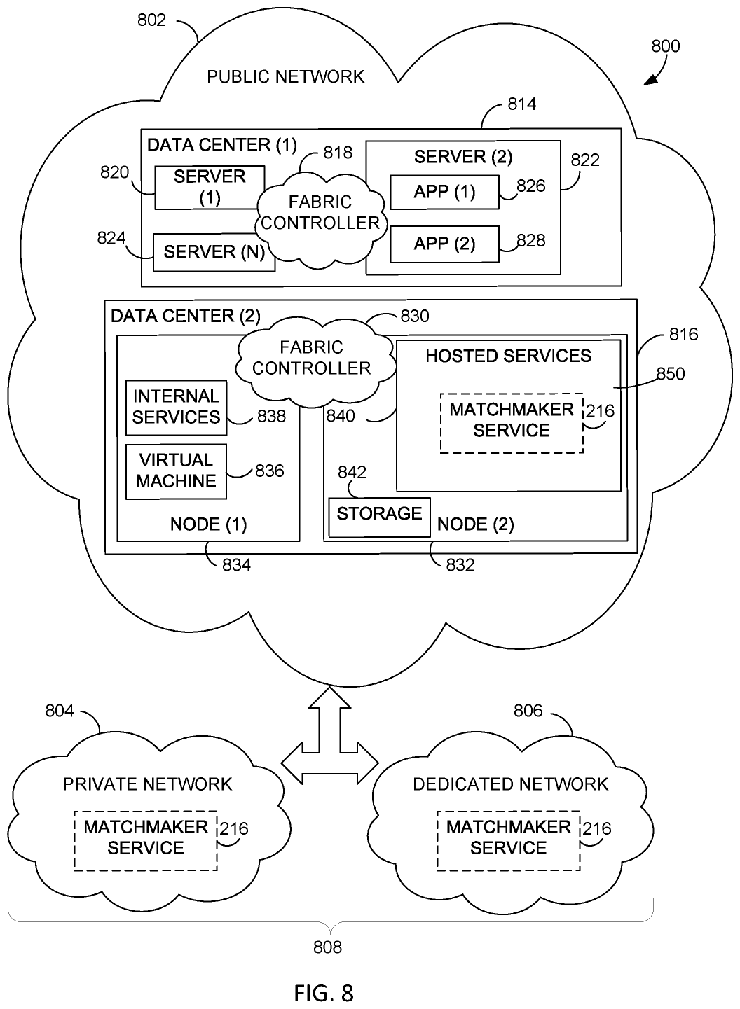

FIG. 2 illustrates a block diagram of a networking environment with a service that reduces data drift in ML models, according to some of the disclose embodiments. The networking environment 200 involves a client computing device 200 and a cloud environment 228 that communicate over network 230. In reference to FIG. 1, computing device 100 represents any number of computing devices 100, cloud environment 228 represents a cloud infrastructure similar to cloud environment 128 or 800 (mentioned below in FIG. 8), and network 230 represents network 130.

Computing device 200 represents any type of client computing device 100. For example, computing device 200 may be a laptop or personal computer with a Web browser that is able to access an online ML modeling service for creating, testing, and implementing ML models. Myriad other examples exist and need not be discussed at length herein other than to generally state that the computing device 200 is able to access various resources in the cloud environment 228.

Cloud environment 228 includes various servers 201 that may be any type of server or remote computing device, either as a dedicated, relational, virtual, private, public, hybrid, or other cloud-based resource. As depicted, servers 201 include a mixture of physical servers 201a and virtual servers 201n, the latter of which are set up as VMs running inside of cloud environment 228. For the sake of clarity, these physical servers 201a and virtual servers 201n are collectively discussed as “servers 201,” unless otherwise indicated. Alternatively, the discussed techniques and services may be implemented in a single or multiple data centers, instead of in a cloud environment 228. For the sake of clarity, embodiments are discussed herein as being implemented in a cloud environment 228.

Servers 201 include or have access to one or more processors 202, I/O ports 204, communications interfaces 206, computer-storage memory 208, I/O components 210, and a communications path 212. Server topologies and processing resources are generally well known to those in the art, and need not be discussed at length herein, other than to say that any server configuration may be used to execute a Matchmaker service 216 as part of an ML model service 214 that operates in the cloud environment 228, as referenced below.

Memory 208 represents a quantity of computer-storage memory and memory devices that store executable instructions and data for use in testing and deploying ML models 250. In some examples, memory 208 stores the ML model service 214 that includes the Matchmaker service 216 and a resource control component 217 as sub-modules. The Matchmaker service 216 and the resource control component 217 may be implemented as executable software instructions, firmware, hardware, or any combination thereof. In operation, the resource control component 217 provides ML model training and prediction tasks related to ML models and invokes the Matchmaker service 216 to deal with data changes. The Matchmaker service 216 includes an online matching pipeline 218 and an offline training pipeline 220 that operate to generate various similarity metrics 280. The online matching pipeline 218 and the offline training pipeline 220 may be implemented through any combination of executable software instructions, firmware, or a combination thereof

Various databases of ML models 250, training data 260, and test data 270 are also used. Specifically, ML model database 226 stores different ML models 250 that are either running, being tested, or otherwise being stored. Training data database 228 stores different training data for the ML models 250. Test data database 230 stores real-time test data 270 that is received in real time from the cloud environment 228. To clarify, the ML models 250 represent ML models for making predictions or performing tasks. For instance, one ML model 250 may make predictions on CPU utilization, another may make predictions on incident routing, etc. Training data 260 is historical data that is used to build or refine the ML models 250 and/or ML model 250A. And the test data 270 is real-time incoming data that is used by the ML model 250A for prediction, testing, or inferencing.

The offline training pipeline 220 divides the training data 260 into batches. In some embodiments, the training data 260 is batched based on time (e.g., per hour, day, week, etc.). Alternatively, the training data 260 may be batched based on other metrics, such as content, data type, user profiles, applications, or the like. For each batch of training data 260. the offline training pipeline 220 trains the ML models 250. Additionally, all batches of the training data 260 are used to train the online matching pipeline 218 in how to select the most ideal ML model 250 to use for incoming test data 270. Incoming testing data 270 is filtered by the online matching pipeline 218 and routed to the most similar ML model 250. Thus, the online matching pipeline 218 acts as a meta-model that determines which ML model 250 should receive an incoming data point, based on the offline training done on the training data 260.

In this manner, the Matchmaker service 216 profiles the various ML models 250 offline with the offline training pipeline 220 and the training data 260. It also matches incoming test data 270 in a data point-by-data point fashion to the correct ML model 250. For instance, if four incoming test data 270 points match closest to ML model 250A, the online matching pipeline 218 routes those four incoming test data 270 points to ML model 250A accordingly. Then, if the next incoming test data 270 point matches more closely with a different ML model 250B, the online matching pipeline 218 routes that single incoming test data 270 point to ML model 250B. This is performed continually, in some embodiments, filtering incoming test data 270 received by the data center cloud environment 228.

In operation, the online matching pipeline 218 identifies a set of ML models 250 (M₁-M_{T}) in the ML model database 226 to choose from during inferencing. Each of these models M₁-M_{T} is trained by the offline training pipeline 220 using a different set of training data 260. For a given set of incoming test data 270, the online matching pipeline 218 identifies a set of the training data 260 most similar to the test data 270 test instance—as determined by a similarity metric, which is described in more detail below. In some embodiments, the offline training pipeline 220 X number of trained ML models 250 corresponding to X batches of training data 260. Other partitioning approaches are also possible. With training data 260 batched and the ML models 250 identified, the online matching pipeline 218 operates to select the most appropriate batch of training data 260 for each point of test data 270 that is received.

To identify the most similar ML model 250, the online matching pipeline 218 is configured to calculate a “similarity metric” 280 for each test data 270 point received by the cloud environment 228. The similarity metrics 280 are calculated with a spatial nearness factor 282 and a temporal nearness factor 284. For the spatial ranking, the offline training pipeline 220 could leverage the Euclidean distance (averaged over all points in a batch of training data 260) for a given test data point 270 to the training data 260. But Euclidean distance may be sensitive to outliers. Batches with few outliers can get large distances and get discarded even if they have many data points that are near the test data 270 point—which would have helped with achieving a better prediction accuracy for that test data 270 point.

So the spatial nearness factor 282 also leverages the way certain ML models 250 (e.g., decision trees) make predictions. A decision tree is a binary tree that organizes training data by splitting along the features at thresholds chosen (using algorithms like classification and regression trees or “CART”) to maximize prediction accuracy on the test data 270. Intuitively, decision trees partition the training data 270 such that similar training samples end up in the same tree “leaf.” At inference time, decision trees find which leaf a test sample is classified into to make predictions. Similarly, the training data 260 is organized into clusters by the offline training pipeline module 220. Because training data 260 points at the same leaf node of a decision tree follow the same path through the tree and lie in nearby regions of the data space, a training batch with more training data 260 points in the same leaf node as a test data 270 point is considered to be more similar to the test data 270 point. In other words, the organized leaf nodes provide telling information about the closeness of different batches of training data 260 to received test data 270, and such closeness is built into the spatial nearness factor 282.

For example, if the leaf node that test data 270 point P is assigned to contains 2 points from Batch 1 (C,D) and 1 point from Batch 2 (G), Batch 1 is considered to be more similar to test data 270 point P than Batch 2. In some embodiments, the following operations are used by the online matching pipeline 218 to find the most-similar training batch. A decision tree (T) is trained on all batches. Points are counted from each batch in each leaf node to T. The online matching pipeline 218 looks up the number of data points from batch T in the same leaf node for each test data 270 point, and the ML model 250 trained on the batch of the looked-up test data 270 point with the largest number of training data 260 is then selected. This approach showed to be less sensitive to outliers than only using the Euclidean distance that only ranked batches based on the points that are near (share a leaf node with) the test sample and do not consider points that are far away.

In some embodiments, the spatial nearness factor 282 also takes into account matching of random forests. Decision trees are known to overfit to the training data 260, leading to a loss of prediction accuracy. Random forests are random ensembles of decision trees (with the randomness coming from sub-sampling of test data points coming from sub-sampling of data points, or sub-sampling of features available at splits, or both) that have demonstrated consistently high prediction accuracy across a range of datasets. They also work well in high-dimensional settings. These improvements in prediction performance led to implementation and use of random forests by the offline training pipeline 218.

In some embodiments, the offline training pipeline 218 trains a random forest (R) on all batches of the training data 260 (X₁,y₁) . . . (X_{T},y_{T}). Tree (Tᵢ) outputs scores Sᵢₜ (number of data points from batch t in the same leaf node) for test point x*. But an approach was needed to combine these scores. Each decision tree may output a distinct ordering of training batches, a consensus ranking is needed across these orderings. Simply adding the counts corresponding to each batch, across trees, may not make sense since the decision trees are constructed by random sub-sampling of features and may not have the same number of levels/leaf nodes. And the rankings from the decision trees only consider spatial similarity/nearness. That all said, temporal nearness was considered since batches arrive over time and more recent batches are expected to be more effective in making predictions on test data (especially if the training or test data distribution is changing over time).

Therefore, in some embodiments, the offline training pipeline 220 uses the Borda count algorithm to create a final ranking of the batches of the training data 260. Specifically, the Borda count ranking algorithm is a ranked voting system that is designed to combine rankings from multiple sources. Given a set of T items (training data batches) and n different rankings (or orderings) of the items, it operates as follows. For item tin ranking i, the number of items that t beats in ranking i is calculated as Borda Score sit. Total Borda Score sₜ is computed using the following equation:

sₜ=Σᵢ₌₁ⁿsᵢₜ*

Then, a final ranking is obtained by sorting sₜ from highest to lowest. This final ranking is referred to herein as the value “MM-Forest” and is set, or used to calculate, spatial nearness factor 282.

The following example illustrates the Borda count approach. Consider items {A,B,C,D} and two associated rankings, r1: {A,B,C,D}, and r2: {C,A,B,D}. The item-wise scores are then s_{A}=3+2=5, s_{B}=2+1=3, s_{C}=1+3=4, and s_{D}=0+0=0. Thus, the final ranking, or MM-Forest value, is r*:{A,C,B,D}, and the highest ranked item is A. Either of these (MM-Forest value or highest ranked item) may be set as the spatial nearness factor 282.

So far, the focus has been on ranking batches in terms of spatial similarity (number of points near the test point in the feature space). The spatial nearness factor 282 therefore covers situations where the test data 270 is obtained from a different part of the feature space than (some of the) training data 260 (covariate shift). To make the Matchmaker service 216 even more robust, the temporal nearness factor 284 is also calculated in addition to prioritize more recent batches to better capture the changing x→y relationship (or concept drift).

To do so, the offline training pipeline 220 determines temporal rankings of the T batches of training data 260 in terms of recency, with the most recent batch ranked highest and the oldest ranked last. These temporal rankings are set as the temporal nearness factors 284 for each batch of testing data 260, or used to calculate the temporal nearness factors 284. To illustrate the latter, the batch T1 may be assigned a temporal nearness factor 284 of 100, older batch T2 may be assigned a temporal nearness factor 284 of 99, still older batch T3 may be assigned a temporal nearness factor 284 of 98, and so on. In other words, the temporal nearness factors 284 of the similarity metrics 280 are assigned based on the time of the training data 260. This allows for older training data 260 to be given less priority that newer training data 260.

Together, the spatial nearness factor 282 and the temporal nearness factor 284 are used to calculate the similarity metric 280 for each test data 270 point that is received. Using the previously disclosed calculations based on Euclidean distance, nodes, forests, and time, the similarity metrics 280 provide robust indicators as to the similarity of incoming test data 270 to the training data 260. These similarity metrics 280 are used by the online matching pipeline 218 to identify the particular training data 260 that is closest to the test data 270 and then, based thereon, the ML models that are associated with the so-identified closest training data 260.

To summarize at least one specific embodiment, the following algorithms are employed by the online matching pipeline 218 and the offline training pipeline 220:

```
Algorithm 1: Offline Training Pipeline 220
Input: Training data batches: (X₁;y₁) . . . (X_{T} ;y_{T} )
Number of trees in Matchmaker: n
Output: Trained models: M₁ . . . M_{T}
Matchmaker: W
for Batch t do
  Train predictive model Mt on data batch (Xt ;yt )
end
Train a random forest R with n trees on the entire data
  {(X₁;y₁) . . . (XT ;y_{T} )}
for Tree Tᵢ 2 R do
  Compute score matrix Si
  /* Sⁱ[kⁱ][t] = Borda Score of Model t in
    leaf node kⁱ of tree Tᵢ */
end
Return Matchmaker W = {(T₁;S₁) . . . (Tn;Sₙ)}
Algorithm 2: Online Matching Pipeline 218
Input: Trained models: M₁ . . . M_{T}
Matchmaker: W
Test data point: x*
Output: Predicted label: y
for (Ti;Si) ε W do
  kᵢ = Leaf node in Tᵢ that x* is mapped to
  sᵢₜ = Sᵢ[kᵢ ][t]
      /* Borda score of Mₜ from tree i for
      test point x*/
end
for Batch t do
  sᵢₜ /* Total Borda score of Mt */
end
Spatial Ranking (rₛₚ) = argsort {s₁ . . . s_{T}}
Temporal Ranking (rₜₚ) = {T;T − 1 . . . 1}
Final Ranking (r*) = Borda count (ᵣₛₚ; rₜₚ)
Set t = r*[0]
Return y =Mₜ (x_)
```

In sum, the main hyperparameters of the matchmaker service 214 include: (a) Number (T) of training batches retained, (b) number of trees in the Random Forest R, and (c) maximum depth of the Random Forest R.

The Matchmaker service 216 dramatically minimizes the processing and memory overhead needed for ML models 250, providing a very scalable service that is able to be implemented on different sizes of data centers and within the cloud infrastructure 228. Overhead is minimized in, at least, the following manner. The Matchmaker service 216 splits the work of computing similarity scores between offline and online computing pipelines, and relies on the offline pipeline to handle a substantial amount of processing. The Matchmaker service 216 trains a random forest to create a data partitioning kernel, and derives data similarity based on the data traversal paths.

This aspect produces more scalable service than traditional models that use Euclidean distance as a similarity metric. The Matchmaker service's use of the random forest kernel only requires computing the path of each test sample once (O₁) as opposed to having to compute a pairwise metric across all data points (O_{N}). The Matchmaker service 216 further reduces inference time by using the training samples to create a cache of pre-computed scores. During inferencing, the Matchmaker service 216 looks up the score for an incoming test data 270 instead of having to compute it from scratch.

The Matchmaker service 216 was evaluated on a number of real-world applications deployed in a production cloud, including, without limitation: a network incident routing (NETIR) ML model 250 and a virtual machine (VM) CPU utilization (VMCPU) ML model 250. These two applications were evaluated over a twelve- and three-month period, respectively, in a large-scale cloud environment. The results showed that, when compared to other deployed models, Matchmaker: (1) yielded a 29% reduction in accuracy variation for NETIR, and a 22% reduction for VMCPU; and (2) improved accuracy, in some instances, by up to 30% for NETIR and up to 5% for VMCPU. Compared to traditional drift services, the Matchmaker service provided 7× and 1.5× times faster ML predictions while achieving better improvements on accuracy.

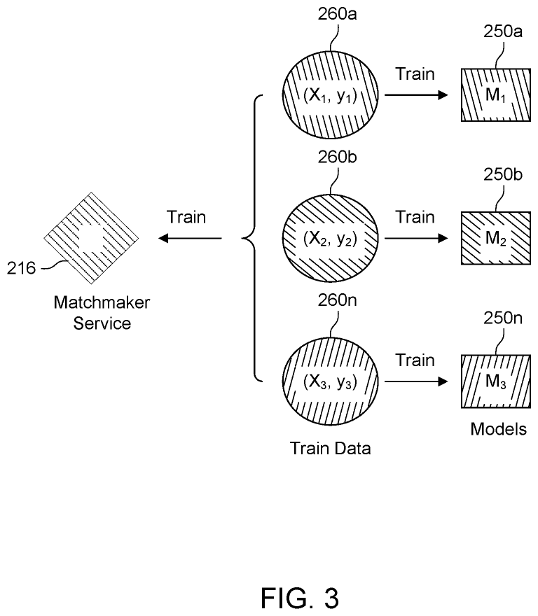

FIG. 3 illustrates a graphical representation of operations of the offline training pipeline 218, according to some of the disclosed embodiments. The offline training pipeline 218 trains the matchmaker service 216 to associate different batches of training data 260a-n with different ML models 250a-n. In some embodiments, the offline training pipeline 218 makes these associates between training data 260a-n and ML models 250a-n using the previously discussed spatial nearness factor 282. These training data 260-to-ML model 250 associations are learned by the Matchmaker service 216 and used to classify and filter incoming test data 270.

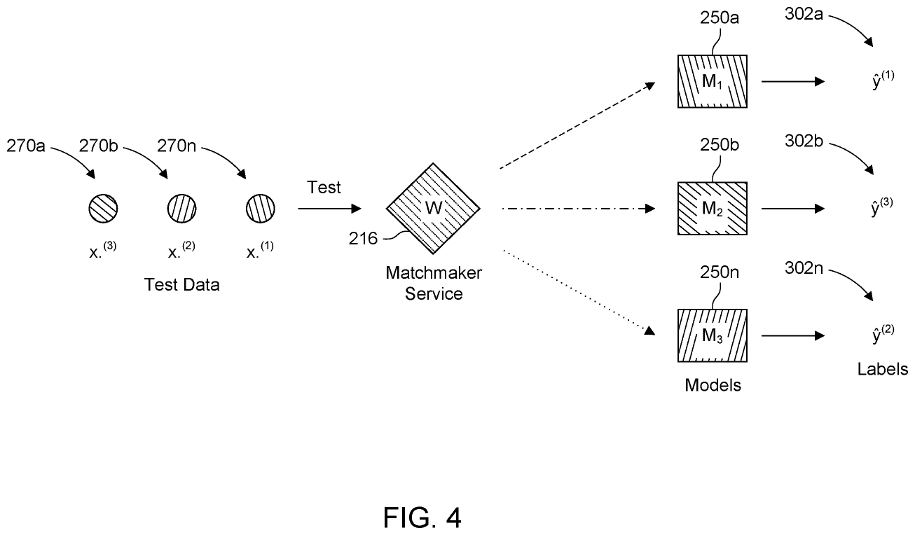

FIG. 4 illustrates a graphical representation of operations of the online matching pipeline 218, according to some of the disclosed embodiments. Income test data 270 received over time. As shown, 3 different data test data points 270a-n are shown being supplied to the matchmaker service 216. At test time, Matchmaker service 216 assigns each test data point 270a-n to the ML model 250a-n the batch of training data 260a-n most similar to the test data points 270a-n. This assignment of test data point 270a-n to ML model 250a-n may then be used for predicting labels 302a-n of the test data points 270a-n.

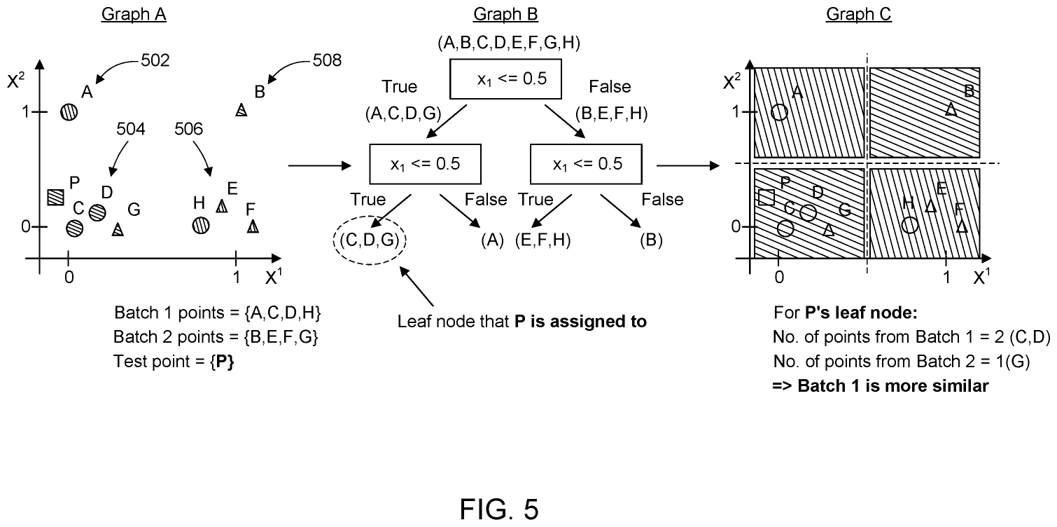

FIG. 5 illustrates graphical representations of partitioning of training data 260 using decision trees, according to some of the disclosed embodiment. Again, some embodiments use decision trees to organize the training data 260 into clusters. FIG. 5 illustrates this for an example with squares representing clusters at leaf nodes of the tree. Three graphs are shown: Graph A, Graph B, and Graph C. Graph A illustrates four different clusters 502, 504, 506, and 508 for two different batches (Batch 1 and Batch 2) of training data 260. Graph B breaks down the cluster and Euclidean distances of the training data 260 that is clustered, showing various decision paths. Because training data 260 points at the same leaf node of a decision tree follow the same path through the tree and lie in nearby regions of the data space, a batch with more data training 260 points in the same leaf node are, in some embodiments, considered to be more similar to each other and to test data 270 that is mapped to the same leaf node. As shown, a leaf node that test data 270 point P is assigned to, contains 2 points from Batch 1 (C,D), and 1 point from Batch 2 (G). Hence, Batch 1 is considered more similar to test data 270 point P than Batch 2.

Again, in some embodiments, the following operations are used by the online matching pipeline 218 to find the most-similar training batch. A decision tree (T) is trained on all batches. Points are counted from each batch in each leaf node to T. The online matching pipeline 218 looks up the number of data points from batch T in the same leaf node for each test data 270 point, and the ML model 250 trained on the batch of the looked-up test data 270 point with the largest number of training data 260 is then selected. Also, some embodiments cache the counts in each leaf node as well to enhance scalability.

As can be seen in Graphs A and C, test data 270 point P is associated with cluster 504, where training data 260 C, D, and G are mapped. Looking at Graph C, the online matching pipeline 218 determines that test data 270 point P is associated with Batch 1 because two (C and D) of three other points in cluster 504 are from Batch 1; whereas, point G is from Batch 2. Therefore, Batch 1 is determined to be more similar to test data 270 point P, and the ML model 250 associated with Batch 2 is selected.

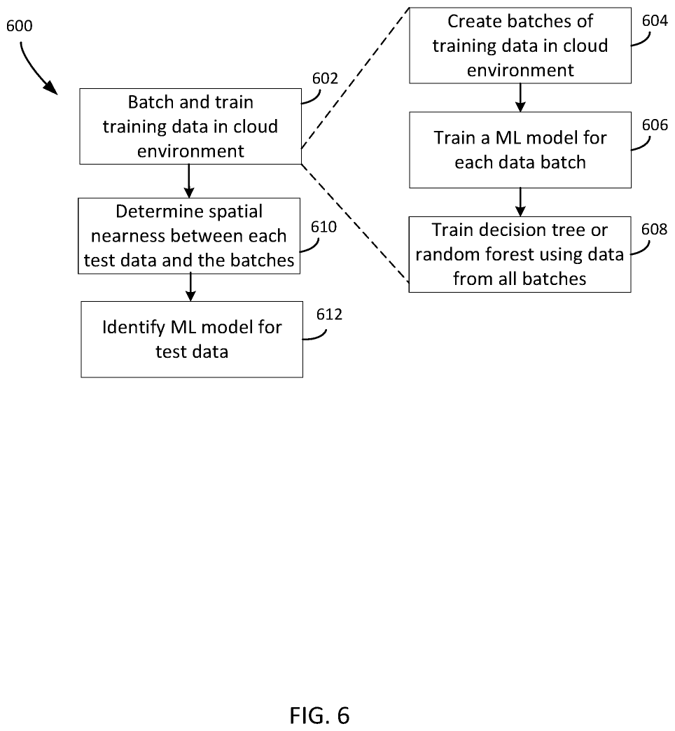

FIG. 6 illustrates a flow chart diagram of an operational flow 600 for associating training data with ML models in a large-scale cloud environment or data center, according to some of the disclosed embodiments. Operational flow 600 involves batching and training data in the cloud environment using an offline training pipeline, as shown at 602. This batching and training involves initially creating multiple batches of the training data, as shown at 604. ML models are trained for each data batch, as shown at 606. An ML model is trained for each created batch, as shown at 606. Also, a decision tree or random forest is trained using data from all batches, as shown at 608. This training concludes the offline training pipeline. The decision tree or random forest is used by an online training pipeline to determine spatial nearness between each test data sample and the created data batches, as shown at 610. This spatial nearness may be used, in some embodiments, to identify the ML model for incoming test data, as shown at 612.

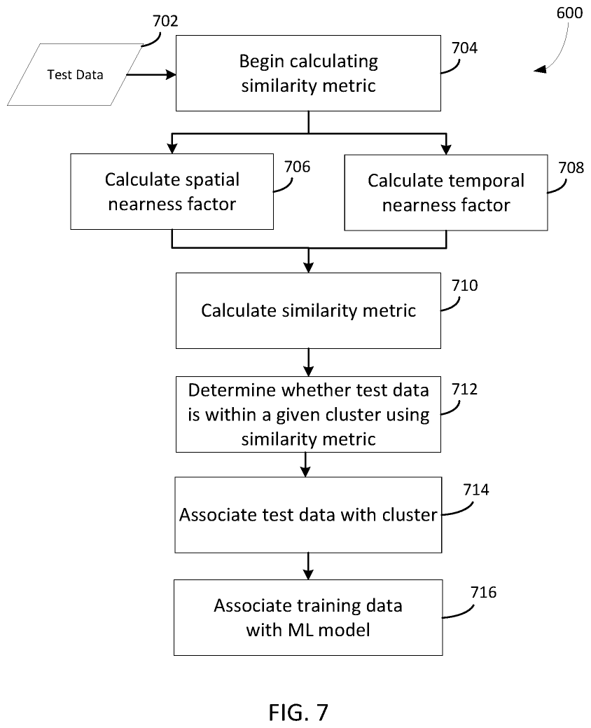

FIG. 7 illustrates a flow chart diagram of an operational flow 700 for selecting an ML model for test data from a plurality of ML models in large-scale cloud environment. As shown at 702, the test data is received by the large-scale cloud environment. An offline training pipeline has previously been executed and performed operations for batching training data in the cloud environment into a plurality of batches, determining first distances for the training data relative to each other, and determining clusters of the training data based on the first distances. Once the test data is received, an online matching pipeline begins calculating a similarity metric for the test data, as shown at 704 As shown at 706, a similarity metric is a spatial nearness factor and a temporal nearness factors. To do so, the online matching pipeline calculates the spatial nearness factor, as shown at 706, and also calculates the temporal nearness factor, as shown at 708. Though, these calculations may be performed in parallel or in the reverse sequence than what is shown. Together, the spatial nearness factor and the temporal nearness factor are used to calculate the similarity metric for the data point, as shown at 710.

Using the similarity metric, the online matching pipeline determines whether the test data is within a given cluster of the training data, as shown at 712. The test data is then associated with the identified cluster, as shown at 714, and the ML model associated with the cluster may also be associated with the training data, as shown at 716.

### Example Cloud-Computing Environment

FIG. 8 illustrates a block diagram of one example of a cloud-computing environment 800 of a cloud infrastructure, in accordance with some of the disclosed embodiments. Cloud-computing environment 800 includes a public network 802, a private network 804, and a dedicated network 806. Public network 802 may be a public cloud-based network of computing resources, for example. Private network 804 may be a private enterprise network or private cloud-based network of computing resources. And dedicated network 806 may be a third-party network or dedicated cloud-based network of computing resources.

Hybrid cloud 808 may include any combination of public network 802, private network 804, and dedicated network 806. For example, dedicated network 806 may be optional, with hybrid cloud 808 comprised of public network 802 and private network 804.

Public network 802 may include data centers configured to host and support operations, including tasks of a distributed application, according to the fabric controller 818. It will be understood and appreciated that data center 814 and data center 816 shown in FIG. 8 are merely examples of suitable implementations for accommodating one or more distributed applications, and are not intended to suggest any limitation as to the scope of use or functionality of examples disclosed herein. Neither should data center 814 and data center 1016 be interpreted as having any dependency or requirement related to any single resource, combination of resources, combination of servers (e.g., servers 820 and 824) combination of nodes (e.g., nodes 832 and 834), or a set of application programming interfaces (APIs) to access the resources, servers, and/or nodes.

Data center 814 illustrates a data center comprising a plurality of servers, such as servers 820 and 824. A fabric controller 818 is responsible for automatically managing the servers 820 and 824 and distributing tasks and other resources within the data center 814. By way of example, the fabric controller 818 may rely on a service model (e.g., designed by a customer that owns the distributed application) to provide guidance on how, where, and when to configure server 822 and how, where, and when to place application 826 and application 828 thereon. One or more role instances of a distributed application may be placed on one or more of the servers 820 and 824 of data center 814, where the one or more role instances may represent the portions of software, component programs, or instances of roles that participate in the distributed application. In other examples, one or more of the role instances may represent stored data that are accessible to the distributed application.

Data center 816 illustrates a data center comprising a plurality of nodes, such as node 832 and node 834. One or more virtual machines may run on nodes of data center 816, such as virtual machine 836 of node 834 for example. Although FIG. 8 depicts a single virtual node on a single node of data center 1016, any number of virtual nodes may be implemented on any number of nodes of the data center in accordance with illustrative embodiments of the disclosure. Generally, virtual machine 836 is allocated to role instances of a distributed application, or service application, based on demands (e.g., amount of processing load) placed on the distributed application. As used herein, the phrase “virtual machine,” or VM, is not meant to be limiting, and may refer to any software, application, operating system, or program that is executed by a processing unit to underlie the functionality of the role instances allocated thereto. Further, the VMs 836 may include processing capacity, storage locations, and other assets within the data center 816 to properly support the allocated role instances.

In operation, the virtual machines are dynamically assigned resources on a first node and second node of the data center, and endpoints (e.g., the role instances) are dynamically placed on the virtual machines to satisfy the current processing load. In one instance, a fabric controller 830 is responsible for automatically managing the virtual machines running on the nodes of data center 816 and for placing the role instances and other resources (e.g., software components) within the data center v16. By way of example, the fabric controller 830 may rely on a service model (e.g., designed by a customer that owns the service application) to provide guidance on how, where, and when to configure the virtual machines, such as VM 836, and how, where, and when to place the role instances thereon.

As described above, the virtual machines may be dynamically established and configured within one or more nodes of a data center. As illustrated herein, node 832 and node 834 may be any form of computing devices, such as, for example, a personal computer, a desktop computer, a laptop computer, a mobile device, a consumer electronic device, a server, and like. VMs machine(s) 836, while simultaneously hosting other virtual machines carved out for supporting other tenants of the data center 816, such as internal services 838, hosted services 840, and storage 842. Often, the role instances may include endpoints of distinct service applications owned by different customers.

In some embodiments, the hosted services 840 include the Matchmaker service 216 configured to perform the various features discussed herein. The Matchmaker service 216, and its pipelines 218-220, may be partially or wholly operated in the public network 802, private network 804, and/or dedicated network 806.

Typically, each of the nodes include, or is linked to, some form of a computing unit (e.g., CPU, GPU, VM, microprocessor, etc.) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the nodes to enable each device to perform a variety of processes and operations. In another instance, the computing unit may encompass a processor (not shown) coupled to the computer-readable medium (e.g., computer storage media and communication media) accommodated by each of the nodes.

The role of instances that reside on the nodes may be to support operation of service applications, and thus they may be interconnected via APIs. In one instance, one or more of these interconnections may be established via a network cloud, such as public network 802. The network cloud serves to interconnect resources, such as the role instances, which may be distributed across various physical hosts, such as nodes 832 and 834. In addition, the network cloud facilitates communication over channels connecting the role instances of the service applications running in the data center 816. By way of example, the network cloud may include, without limitation, one or more communication networks, such as LANs and/or wide area networks WANs. Such communication networks are commonplace in offices, enterprise-wide computer networks, intranets, and the Internet, and therefore need not be discussed at length herein.

### Additional Examples

Some examples are directed to a method for selecting a machine learning (ML) model for test data from a plurality of ML models in large-scale cloud environment. The method comprises: batching training data in the cloud environment into a plurality of batches; determining first distances for the training data relative to each other; determining clusters of the training data based on the first distances; determining a second distance for the test data relative to the training data; associating the test data with a first cluster based on the second distance; and processing the test data by the ML model associated with the first cluster.

In some examples, batching of the training data is performed by offline before the test data is received by the large-scale cloud environment.

Other examples are directed calculating a similarity metric that includes the second distance for the test data relative to the training data as part of a spatial nearness factor and also includes a temporal nearness factor based on a time that the test data being received by the large-scale cloud environment.

In some examples, association of the test data with the first cluster is, at least partially, based on a temporal nearness metric indicative of a time that the test data being received by the large-scale cloud environment.

Other examples are directed to: partitioning the training data batches using a random forest; comparing the batches, spatially, to the test data; and basing said association of the test data with the first cluster, at least in part, on said comparison of the batches to the test data.

In some examples, the data batches are partitioned by training a random forest based on the training data on all of the batches.

In some examples, the ML model is a network incident routing ML model.

In some examples, the ML model is a virtual machine (VM) CPU utilization (VMCPU) ML model.

In some examples, further applying the Borda Count algorithm to rank the batches of the training data.

Other examples are directed to using rankings from application of the Borda Count algorithm to select the ML model for the test data.

Other examples are directed to one or more servers configured for selecting an ML model for test data from a plurality of ML models in large-scale cloud environment. The one or more servers comprise: memory embodied with executable instructions for associating the test data with training data that are associated with different ML models; and at least one processor programmed for: batching training data in the cloud environment into a plurality of batches, determining first distances for the training data relative to each other, determining clusters of the training data based on the first distances, determining a second distance for the test data relative to the training data, associating the test data with a first cluster based on the second distance, and processing the test data by the ML model associated with the first cluster.

In some examples, the at least one processor is further programmed to: partition a forest of the training data on the batches, compare the batches, spatially, to the test data, and base said association of the test data with the first cluster, at least in part, on said comparison of the batches to the test data.

In some examples, at least one processor is further programmed to compute a similarity metric that associates the test data with the ML model.

In some examples, similarity metric comprises a spatial nearness factor indicative of distances between the test data and the training data and a temporal nearness factor indicative of time of receipt of the test data by the large-scale cloud environment.

Some examples are directed to one or more computer-storage memory devices embodied with executable operations that, when executed by one or more processors, are configured to select an ML model for test data from a plurality of ML models in large-scale cloud environment. The executable operations comprise: an offline training pipeline executable for: batching training data in the cloud environment into a plurality of batches, determining first distances for the training data relative to each other, and determining clusters of the training data based on the first distances; and an online matching pipeline configured for: calculating a similarity metric for the test data indicative of spatial nearness and temporal nearness, and selecting the ML model for processing the test data based on the similarity metric.

In some examples, the offline training pipeline is further configured for applying the Borda Count algorithm to rank the batches of the training data.

In some examples, the offline training pipeline is executable in a data center.

In some examples, the online matching pipeline is executable in a data center.

In some examples, the ML model is a virtual machine (VM) CPU utilization (VMCPU) ML model.

In some examples, the offline training pipeline is further configured for partitioning a forest of the training data on the batches; and wherein the online matching pipeline is further configured for: comparing the batches, spatially, to the test data, and basing said association of the test data with the first cluster, at least in part, on said comparison of the batches to the test data.

While the aspects of the disclosure have been described in terms of various examples with their associated operations, a person skilled in the art would appreciate that a combination of operations from any number of different examples is also within scope of the aspects of the disclosure.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for selecting a machine learning (ML) model for test data from a plurality of ML models in a cloud environment, the method comprising:
batching training data in the cloud environment into a plurality of batches;
determining first distances for the training data relative to each other;
determining clusters of the training data based on the first distances;
determining a second distance for the test data relative to the training data;
associating the test data with a first cluster based on the second distance; and
processing the test data by the ML model associated with the first cluster.

2. The method of claim 1, wherein said batching of the training data is performed by offline before the test data is received by the large-scale cloud environment.

3. The method of claim 1, further comprising calculating a similarity metric that includes the second distance for the test data relative to the training data as part of a spatial nearness factor and also includes a temporal nearness factor based on a time that the test data being received by the large-scale cloud environment.

4. The method of claim 1, wherein said association of the test data with the first cluster is, at least partially, based on a temporal nearness metric indicative of a time that the test data being received by the large-scale cloud environment.

5. The method of claim 1, further comprising:
partitioning a forest of the training data on the batches;
comparing the batches, spatially, to the test data; and
basing said association of the test data with the first cluster, at least in part, on said comparison of the batches to the test data.

6. The method of claim 5, wherein the forest is partitioned by training a random data sample of the test data on all of the batches.

7. The method of claim 1, wherein the ML model is a network incident routing ML model.

8. The method of claim 7, wherein the ML model is a virtual machine (VM) CPU utilization (VMCPU) ML model.

9. The method of claim 1, further applying the Borda Count algorithm to rank the batches of the training data.

10. The method of claim 1, further comprising using rankings from application of the Borda Count algorithm to select the ML model for the test data.

11. One or more servers configured for selecting a machine learning (ML) model for test data from a plurality of ML models in large-scale cloud environment, the one or more servers comprising:
memory embodied with executable instructions for associating the test data with training data that are associated with different ML models; and
at least one processor programmed to:
batching training data in the cloud environment into a plurality of batches,
determining first distances for the training data relative to each other,
determining clusters of the training data based on the first distances,
determining a second distance for the test data relative to the training data,
associating the test data with a first cluster based on the second distance, and
processing the test data by the ML model associated with the first cluster.

12. The one or more servers of claim 11, wherein the at least one processor is further programmed to:
partition a forest of the training data on the batches,
compare the batches, spatially, to the test data, and
base said association of the test data with the first cluster, at least in part, on said comparison of the batches to the test data.

13. The one or more servers of claim 11, wherein the at least one processor is further programmed to compute a similarity metric that associates the test data with the ML model.

14. The one or more servers of claim 13, wherein the similarity metric comprises a spatial nearness factor indicative of distances between the test data and the training data and a temporal nearness factor indicative of time of receipt of the test data by the large-scale cloud environment.

15. One or more computer-storage memory devices embodied with executable operations that, when executed by one or more processors, are configured to select a machine learning (ML) model for test data from a plurality of ML models in large-scale cloud environment, comprising:
an offline training pipeline executable for:
batching training data in the cloud environment into a plurality of batches,
determining first distances for the training data relative to each other, and
determining clusters of the training data based on the first distances;
an online matching pipeline configured for:
calculating a similarity metric for the test data indicative of spatial nearness and temporal nearness, and
selecting the ML model for processing the test data based on the similarity metric.

16. The one or more computer-storage memory devices of claim 15, wherein the offline training pipeline is further configured for applying the Borda Count algorithm to rank the batches of the training data.

17. The one or more computer-storage memory devices of claim 15, wherein the offline training pipeline is executable in a data center.

18. The one or more computer-storage memory devices of claim 15, wherein the online matching pipeline is executable in a data center.

19. The one or more computer-storage memory devices of claim 15, wherein the ML model is a virtual machine (VM) CPU utilization (VMCPU) ML model.

20. The one or more computer-storage memory devices of claim 15,
wherein the offline training pipeline is further configured for partitioning a forest of the training data on the batches; and
wherein the online matching pipeline is further configured for:
comparing the batches, spatially, to the test data, and
basing said association of the test data with the first cluster, at least in part, on said comparison of the batches to the test data.
